(19) United States
(12) Patent Application Publication
(10) Pub. No.: US 2011/0136364 A1
(43) Pub. Date: Jun. 9, 2011

(54) ELECTRICAL CONNECTORS

(75) Inventor: Laurent Montrade, Chatillon-sur-Chalaronne (FR)

(73) Assignee: Carrier Corporation, Farmington, CT (US)

(21) Appl. No.: 13/054,883

(22) PCT Filed: Jul. 29, 2008
(86) PCT No.: PCT/IB08/02870

§ 371 Date: Jan. 19, 2011

(51) Int. Cl. H01R 13/52; H01R 13/62; H01R 24/00

(52) U.S. Cl. 439/271; 439/345; 439/660

(57) ABSTRACT

An electrical connector (2) comprises a pin connector part (4) comprising a plurality of terminal pins (8) and a socket connector part (6) for receiving the terminal pins (8). The socket connector part (6) comprises a socket housing (40), A plurality of terminals (42) within said housing (40) for making an electrical connection with said terminal pins (8) and a seal (54) on a face portion (62) of the socket housing (40). The seal (54) comprises a plurality of openings (56) through which the terminal pins (8) may extend. Sealing surfaces (34) are provided around the terminal pins (8) for sealing engagement with the seal (54) around the openings (56).

The present invention relates to electrical connectors and in particular, but not exclusively, to electrical connectors for use in supplying power to a compressor such as might be used in a transport refrigeration unit. An example of such a connector is disclosed in U.S. Pat. No. 5,664,959.

Typically such connectors comprise a pin part comprising a plurality of terminal pins which in use extend into the compressor housing for connection to electrical components of the compressor and a socket part connected to a power supply cable and having terminal connectors arranged within a socket housing for receiving the terminal pins. Typically the power supply is a three phase power supply, so that the connector comprises three terminal pins and three terminal connectors.

It is important in many applications that such electrical connectors are sealed so as to prevent ingress of dirt or moisture into the connector, as such ingress could cause shorting within the connector.

The present invention in a first aspect seeks to provide an electrical connector with improved sealing.

From a first aspect, the invention provides an electrical connector comprising: a pin connector part comprising a plurality of terminal pins; and a socket connector part for receiving said terminal pins, said socket connector part comprising: a socket housing; a plurality of terminals within said housing for making an electrical connection with said terminal pins; and a seal provided on a face portion of said socket housing and comprising a plurality of openings through which said terminal pins may extend into said socket housing and for sealing said face portion when said connector parts are joined together.

In accordance with the invention, therefore, a face of the socket housing is provided with a seal with which sealing surfaces on the pins cooperate to effect a seal as the socket and pin connector parts are assembled together.

The invention also extends to just the socket connector part defined above, so from a second aspect the invention provides a socket connector part for receiving terminal pins, said socket connector part comprising: a socket housing; a plurality of terminals within said housing for making an electrical connection with said terminal pins; and a seal provided on a face portion of said socket housing and comprising a plurality of openings through which said terminal pins may extend into said socket housing.

The seal may be formed in situ on the socket, but in certain embodiments it is made as a separate element which is mounted to the socket housing. To facilitate mounting, the socket housing and the seal may be provided with interengaging location means. This assists, for example in obtaining the correct alignment of the openings in the seal with the terminals within the socket housing. In one arrangement the locating means comprise one or more posts on the sealing element and corresponding openings in the socket housing.

In one embodiment, the seal element is provided on a recessed surface in the socket housing face and comprises a peripheral seal for sealing around the edge of the seal element. In one arrangement the peripheral seal may comprise one or more fins extending circumferentially around the seal element.

The terminals of the socket part are in one embodiment provided in pockets which open onto the face portion of the socket housing. In certain embodiments, the pockets are provided with raised lips on the face portion so as to improve the seal with the socket seal.

The seal may be made from any suitable resilient material such as silicone rubber. However, any material which provides the requisite sealing capabilities and electrical insulation can be used.

The terminal pins may, as is known in the art, be provided with spade tabs affixed to a distal side portion of a circular section pin and the socket terminals may comprise spade terminals to receive the spade tabs. In such arrangements, therefore, the terminal pins will not have a circular cross section. However, due to the resilience of the socket seal, the openings in the socket seal can still be circular for close engagement around the circular parts of the pins, the openings deforming to accommodate the passage of the spade parts of each pin during assembly together of the connector parts.

The openings in the socket seal are preferably smaller in cross section than the parts of the terminal pins received therein so that a sealing engagement is obtained between the outer circumferences of the terminal pins and the openings.

Typically a terminal pin will be mounted to a support plate by an insulator, typically formed of glass. This prevents the support plate becoming live during use. In one arrangement in accordance with the invention, a pin connector sealing surface is formed on an insulator part of the terminal pin.

The seal opening may have a flared e.g. arcuate mouth to facilitate receiving the pins.

Sealing may also be effected by face to face sealing around the openings.

In order to maintain the sealing engagement of the pin and socket connector parts and to prevent disengagement of the connector parts in use, the connector may comprise a lock for securing the connector parts together. This is particularly important in situations where the connector may be subjected to vibration and shock loads, for example on a transport refrigeration unit.

In one embodiment the lock comprises a locking element mounted to the socket part and which is engageable with a locking portion of a terminal pin of the connector. In particular the locking element may lockingly engage the spade tab provided on the terminal pin.

This is in itself believed to be a novel and inventive arrangement allowing for a compact connector locking construction, even in situations where sealing is not required between the connector parts. From a further aspect therefore, the invention provides an electrical connector comprising: a pin connector part comprising a plurality of terminal pins; and a socket connector part for receiving said pins, said second part comprising: a socket housing; and a plurality of terminals within said socket housing for receiving said pins; and a lock for securing said connector parts together, said lock comprising: a locking element mounted to said socket housing and lockingly engageable with a locking portion of a said terminal pin.

The locking element may be configured such that it lockingly engages the terminal pin automatically upon insertion of the relevant terminal pin into the socket part. Preferably, however, the locking element is selectively engageable with the terminal pin to allow the connector to be locked or unlocked as desired. In one arrangement therefore, the locking element comprises an element which is selectively movable between a locking position in which it lockingly engages the terminal pin and a non-locking position in which it does not. The terminal pin can be inserted into the socket with the locking element in its non-locking position and once the terminal pin is properly located, the locking element moved to its locking position.

The locking element may be movable in any appropriate direction, for example in an axial direction, but preferably it is rotatable.

The locking element may be provided with a secondary lock which retains the locking element in its locking position to avoid inadvertent separation of the connection parts in use. In one arrangement the secondary lock comprises a detent provided on the socket part and a cooperating locking formation provided on the locking element.

Preferably the cooperating locking formation is selectively disengageable from the detent to allow separation of the connector parts.

In one arrangement, the cooperating locking formation is provided on a locking arm coupled to, e.g. formed integrally with, and movable with the locking element. In a preferred arrangement, the detent and formation are configured such that the act of moving the locking element into locking engagement with the terminal pin automatically effects the secondary locking. Conveniently, therefore, the detent and locking formation may have ramped surfaces which can ride over one another as the locking element is moved to its locking position, the locking formation then dropping into locking engagement with the detent. The locking arm may be elastically deformable or otherwise resiliently mounted to the locking element to facilitate this.

To release the secondary lock, the arm can be moved to disengage the locking formation from the detent. Conveniently, the locking arm is elongate, with the locking formation at one end and a pivot in a mid length section. The other end of the locking arm may be depressed to pivot the locking formation out of engagement with the detent. The release end of the arm may extend adjacent an actuating portion of the locking element such that the release movement can be obtained by squeezing the two parts towards one another.

To prevent ingress of dirt or moisture into the socket housing around the locking element, a suitable seal may be provided. In one embodiment the seal is a resilient element having a bore for receiving the locking element and circumferentially extending sealing elements for engagement with the socket housing.

As discussed above, it is typical for connectors to be used with a three phase power supply and therefore to have three terminal pins. It is important when assembling the connector parts together to ensure that the pins are connected to the correct terminals. In certain embodiments of the invention, therefore, means are provided to ensure the correct relative orientation of the connector parts. In one arrangement, the terminal pin connector part may be arranged within a pocket within which the socket connector is at least partially received, and the configuration of the pocket and the socket connector being such that the socket connector can only be received within the pocket in the correct orientation.

This is in itself believed to be a novel and inventive arrangement, so from a further aspect the invention provides an electrical connector comprising: a pin connector part comprising a plurality of terminal pins; and a socket connector part for receiving said pins, said second part comprising: a socket housing; and a plurality of terminals within said housing for receiving said pins; wherein said pin connector part is arranged within a pocket for at least partially receiving said socket connector and wherein the configuration of the pocket and the socket connector are such that the socket connector can only be received within the pocket in a particular orientation.

A preferred embodiment of the invention will now be described by way of example only with reference to the accompanying drawings in which:

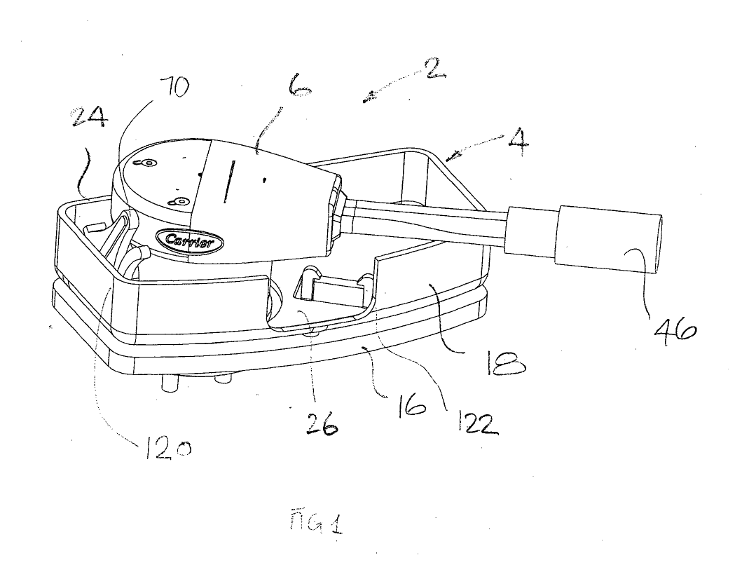

FIG. 1 is a perspective view of a connector in accordance with the invention;

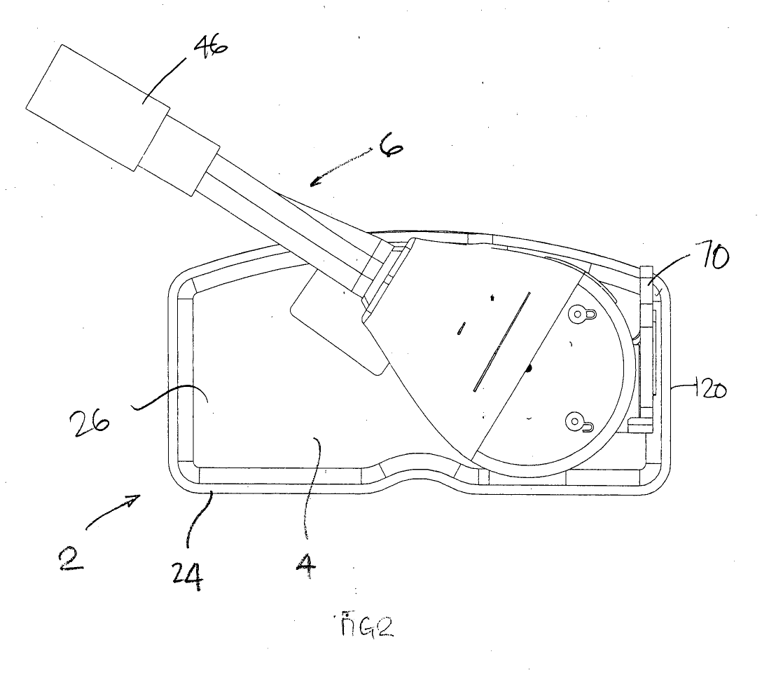

FIG. 2 is a plan view of the connector of FIG. 1;

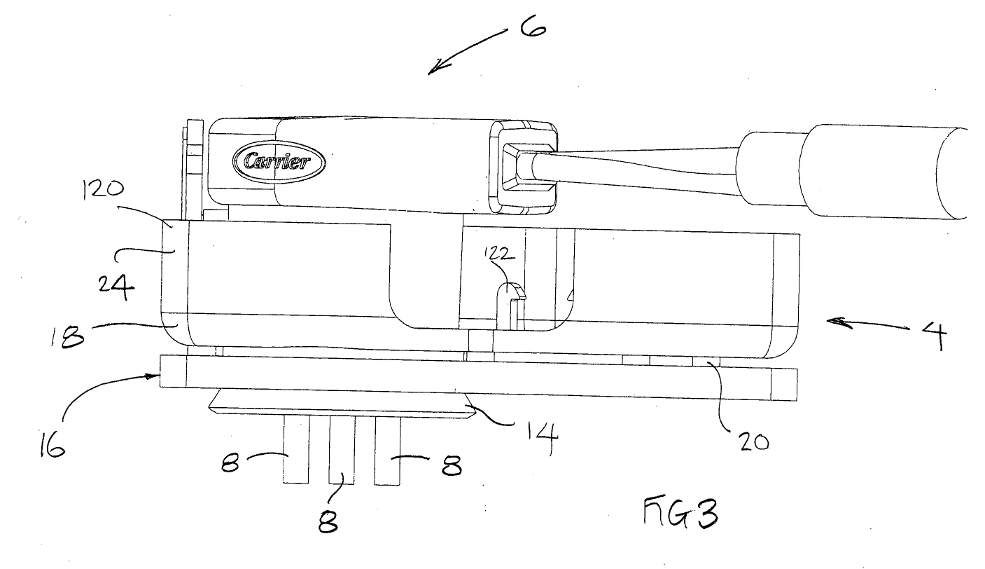

FIG. 3 is a side elevation of FIG. 1;

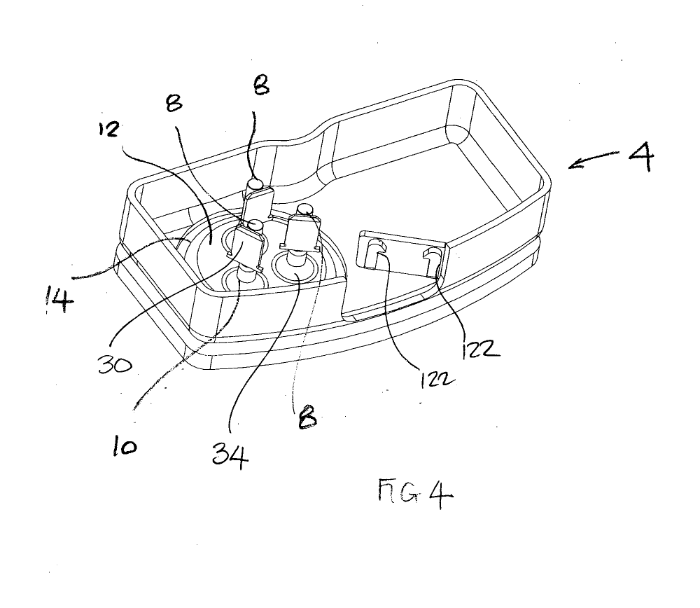

FIG. 4 is a perspective view of the pin part of the connector of FIG. 1;

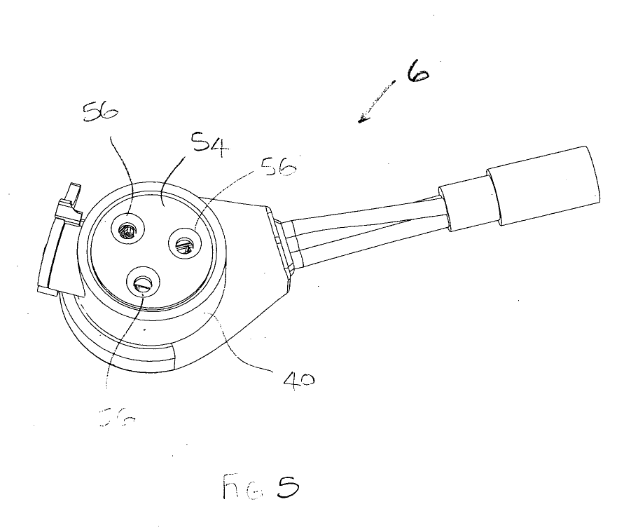

FIG. 5 is a perspective view of the socket part of the connector of FIG. 1;

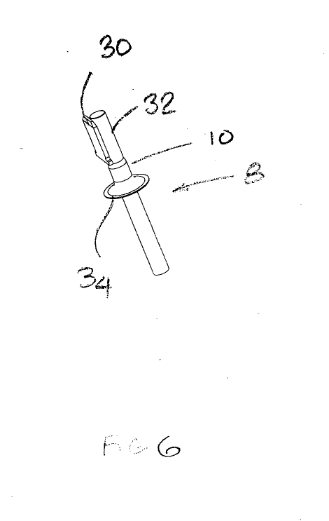

FIG. 6 is a perspective view of a terminal pin of the connector of FIG. 1;

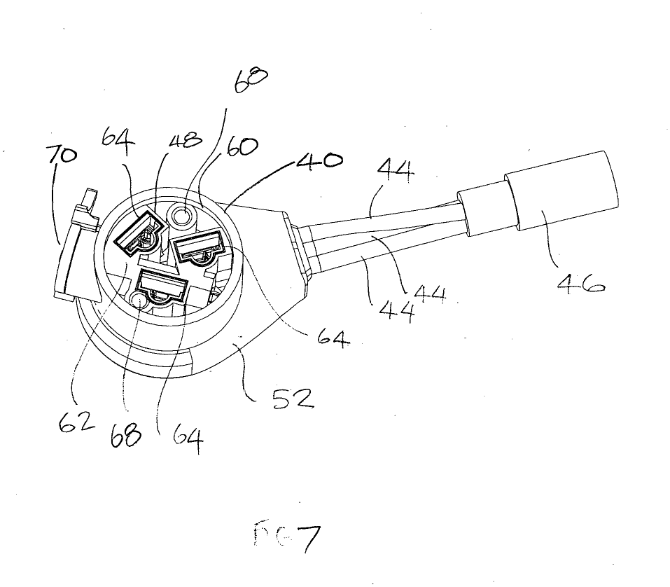

FIG. 7 is a view similar to FIG. 4, but with the sealing member removed such that internal components of the socket connector can be seen;

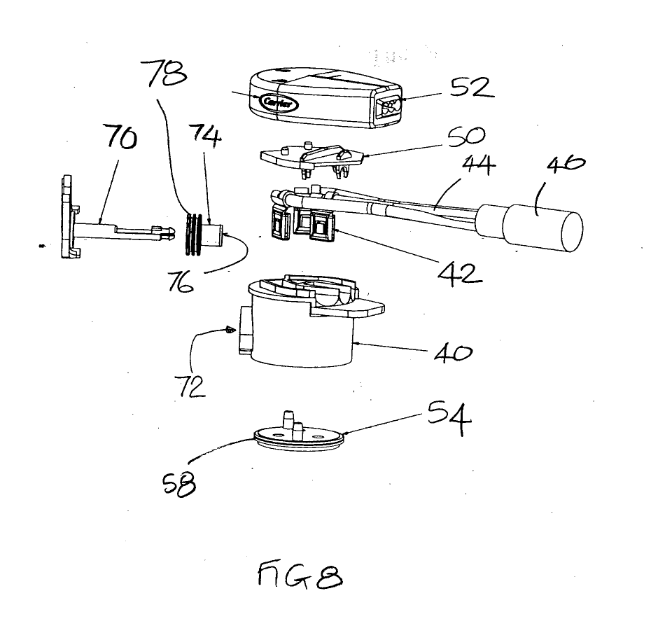

FIG. 8 shows an exploded view of the socket connector part;

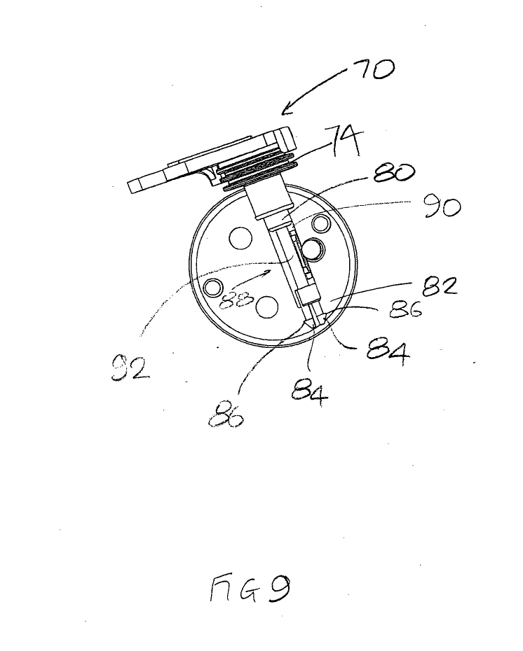

FIG. 9 shows detail of the connector locking mechanism;

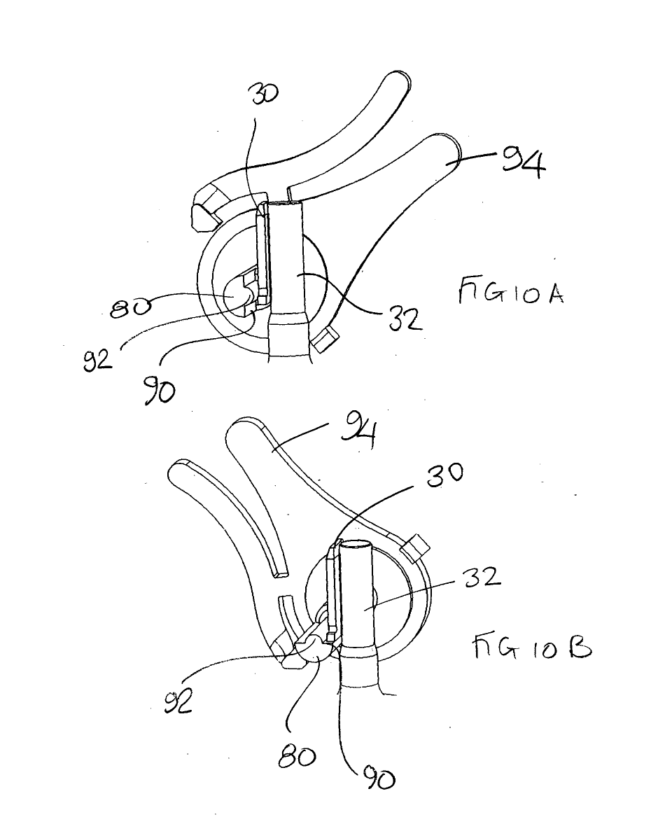

FIG. 10a shows the locking element of the connector in an unlocked position;

FIG. 10b shows the locking element in a locking position; and

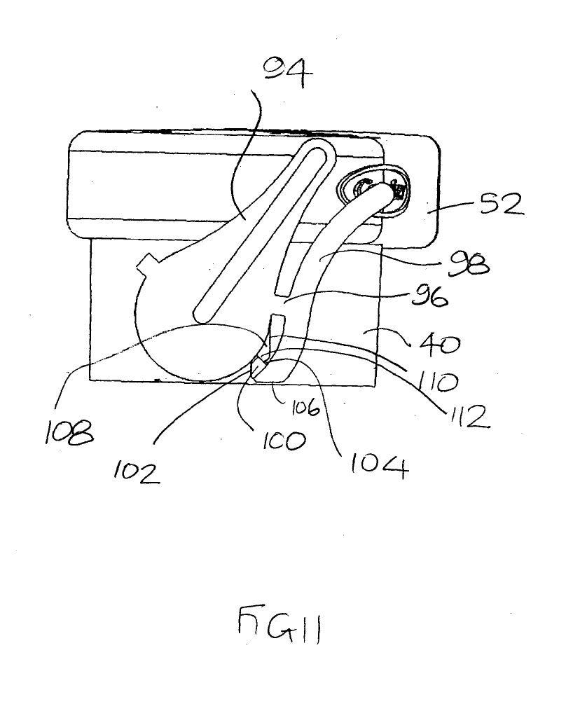

FIG. 11 shows the interaction of the locking element with the socket connector housing.

With reference to FIG. 1, a connector 2 in accordance with the invention comprises a pin part 4 and a socket part 6.

As can be seen best from FIG. 4, the pin part 4 is a Fusite type connector and comprises three terminal pins 8. The terminal pins 8 are attached through glass insulators 10 to the upper surface 12 of a cup-shaped mounting plate 14 which is mounted to extend through the wall, for example, of an hermetic compressor. The mounting plate 12 is attached to a base 16 which is typically a part of the compressor housing wall. Thus whilst shown as a separate component in this embodiment, it may be an integral part of the compressor housing wall. In this embodiment, a shroud part 18 is mounted to the base 16 by welds 20. The shroud part 18 may mot be necessary in all applications, but it does provide some protection for the pin connector part 4.

The shroud 18 is formed as a pocket to at least partially receive the socket connector part 6. The pocket is defined by a wall 24 upstanding from a base surface 26.

As can be seen from FIG. 6, each terminal pin 8 comprises a spade tab 30 attached, e.g. brazed or welded, to the upper part 32 of the pin 8.

Turning now to the socket part 6, this comprises a moulded plastics housing 40 which houses three terminals 42 which are connected respectively to cables 44 of a three-phase power supply cord 46 and for receiving the spade tabs 30 of the terminal pins 8. The terminals 42 are received in terminal pockets 48 within the socket housing 40. Due to the orientation of the spade tabs 30 on the terminal pins 8 and the orientation of the terminal pockets 48, the pin connector part 4 and socket connector part 6 can only be assembled in one relative rotational position.

The upper end of socket housing 40 is closed by a plastics plate 50 which is held in position by an over-moulded plastics cap 52. This ensures that the external part of the socket connector 6 is sealed to moisture and dirt.

The other end of the socket housing 40 has a face 62 which is sealed and closed by a disc-like seal member 54 made of a resilient, electrically insulating material such as silicone rubber. The seal member 54 has three openings 56 which in use are aligned with the terminal pockets 48 within the socket housing 40. The externally facing surfaces of the openings 56 are flared so as to receive the lower portions 34 of the terminal pins 8 of the pin connector part 4. The minimum diameter of each opening 56 is smaller than the diameter of the insulator 10 of each the terminal pin 8 so that a sealing engagement will be formed between the inner circumference of each opening 56 and the outer circumference of the insulator 10 extending therethrough.

The seal member 54 further comprises a pair of circumferentially extending sealing fins 58 for engagement with the internal peripheral surface 60 of the socket housing 40. The seal member 54 is received and supported on the front face 62 of the socket housing 40. The terminal pockets 48 have raised lips 64 on the face 62 so as to improve the seal between the seal member 54 and the housing 40 around the pockets 48 when the connector parts 4,6 are assembled.

The seal member 54 is provided with two upstanding, integrally moulded pins 66 which in use engage in corresponding bores 68 provided in the face 62 of the socket housing 40. This ensures that the seal member 54 is properly located on the socket housing 40 in use.

The socket housing 40 also accommodates a locking element 70 which extends into the socket housing 54 through a bore 72 formed in a wall of the socket housing 40. The bore 72 intersects one of the terminal pockets 48 of the socket housing 40. The locking element 70 is located in the bore 72 by a seal member 74 which has a central opening 76 for receiving the locking element and a series of peripheral ribs 78 for engaging the internal surface of the housing bore 72 to prevent ingress of moisture or dirt into the housing through the bore 72.

The locking element 70 comprises a shaft 80 which passes through the terminal pocket 48. The distal end 82 of the element 70 is bifurcated having two generally semicircular limbs 84. Each limb has a detent surface 86 for engaging with a portion of the socket housing 40 when the locking element 70 is fully inserted into the housing 40, to prevent the locking element 70 from being withdrawn. The shaft 80 also comprises a semi-annular recess 88 which defines a planar locking surface 90 arranged on one side of a reduced diameter shaft portion 92.

The locking element 70 further comprises an actuating arm 94 by means of which the locking element may be rotated in the bore 72. Attached to (preferably integrally moulded with) the actuating arm 94 by a flexible pivot 96 is a lock release arm 98. A locking lug 100 is provided at the distal end of the locking arm 98. The locking lug 100 has a sloping distal surface 102 and a locking surface 104. As shown in FIG. 11, the distal end of the locking arm 98 is formed with a generally flat surface 106, which in use in the locking position of the locking arm 98 lies generally co-planar with the end surface of the socket housing 40. As further shown in FIG. 11, the socket housing 40 has a detent 108. The detent has a sloping surface 110 and a locking surface 112.

The assembly and interaction of the connector parts will now be described.

As will be seen from FIGS. 1 to 3, when assembled, the socket connector part 6 is received within the upstanding wall 24 of the shroud part 18. The configuration of the two parts is such that they may only be assembled in one relative orientation. In particular, they can only be assembled when the locking element 70 is located adjacent an end portion 120 of the wall 24. In any other orientation, the locking element will interfere with the upstanding wall 24 or with upstanding formations 122 formed on the base surface 26. This helps the user present the socket connector part 6 in the correct orientation to the pin connector part 4 such that the terminal pins 8 will align correctly with the socket terminal pockets 48.

During assembly, although the openings 56 in the seal member 54 are circular and the terminal pins 8 have wider spade tabs 30 attached thereto, the resilience of the seal member material will allow the terminal pins 8 to pass through the openings 56 without damaging the seal member 54.

The connector parts 4,6 can only be assembled together when the locking element 70 is in an unlocked position as shown in FIG. 10A. In this position, the terminal pins 8 may pass the planar locking surface 90 of the locking element 70 to engage with the socket terminals 42.

When the parts 4,6 are fully engaged with each other, the lower portions 34 of the terminal pin insulators 10 engage within the tapered openings 56 of the seal member 54. Due to the inner diameter of the openings 56 being smaller than the outer diameter of the insulators 10, a seal is formed around the circumference of the terminal pins 8.

A seal is also formed between the upper surface 12 of the plate 14 and the seal member 54 around the openings 56. Moreover, the pressure exerted by the pin connector 4 on the seal member 54 pushes the seal member 54 firmly against the raised lips 64 around the terminal pockets 48 to seal the pocket openings. This pressure may also cause the sealing member to expand radially outwardly, thereby improving the sealing engagement of the sealing fins 58 with the internal peripheral surface 60 of the socket housing 40.

The locking element 70 can be rotated from its unlocked position (shown in FIG. 10A) through 90° to its locking position (shown in FIG. 10B and FIG. 1). In this position, the planar locking surface 90 provided on the locking element 74 engages under the end of the spade tab 30 of the relevant terminal pin 8, preventing the separation of the two connector parts. As the locking element 74 is rotated from its unlocked to its locked position, the locking formation 100 on the locking arm 98 of the locking element 94 engages and locks behind the detent 108 formed on the socket housing 40. In particular, the respective sloping surfaces 110,102 of the locking arm 98 and detent 108 will ride over one another until the locking formation 100 passes the detent 108, whereupon the resilience of the locking arm pivot 96 will cause the locking formation 100 to snap into position behind the detent 108. In this position, the actuating arm 94 of the locking element cannot be rotated towards its unlocking position. Moreover, over-rotation of the locking element 70 is prevented by the surface 106 of the locking arm 98 abutting the base surface 26. In this position the two connector parts are firmly maintained together with sufficient pressure to produce a good seal between the two parts.

When it is desired to release the connector parts, the user merely has to press on the upper end of the locking arm 98 in order to pivot the locking formation 100 out of engagement with the housing detent 108 whereupon the actuating arm 94 may be rotated so as to bring the locking surface 90 of the locking element 70 out of engagement with the spade tab 30 of the terminal pin 8, thereby allowing the connector parts 4, 6 to be separated.

It will be understood that the above description is by way of example only and that other arrangements will fall within the scope of the invention as defined by the accompanying claims. For example, the movable part of the secondary lock may be provided on the socket housing rather than on the locking element.

1. An electrical connector comprising:
a pin connector part comprising a plurality of terminal pins; and
a socket connector part for receiving said terminal pins, said socket connector part comprising:
a socket housing;
a plurality of terminals within said housing for making an electrical connection with said terminal pins; and
a seal provided on a face portion of said socket housing and comprising a plurality of openings through which said terminal pins may extend into said socket housing and for sealing said face portion when said connector parts are joined together.

2. An electrical connector as as recited in claim 1 wherein the seal is a separate element mounted to the socket housing and the seal element is provided on a recessed surface in the socket housing face and comprises a peripheral seal for sealing around the edge of the seal.

3. (canceled)

4. (canceled)

5. An electrical connector as as recited in claim 1 wherein the socket housing and the seal element are provided with interengaging location means.

6. An electrical connector as recited in claim 1 wherein the terminals of the socket part are provided in pockets which open onto the face portion of the socket housing and the pockets comprise raised lips on the face portion.

7. (canceled)

8. An electrical connector as recited in claim 1 wherein the terminal pins comprise spade tabs affixed to a distal side portion of a circular section pin and the socket terminals comprise spade terminals to receive the spade tabs.

9. (canceled)

10. (canceled)

11. An electrical connector as recited in claim 1 wherein the openings in the socket seal are smaller in cross section than the parts of the terminal pins received therein so that a sealing engagement is obtained between the outer circumferences of the terminal pins and the openings.

12. An electrical connector as recited in claim 1 further comprising a lock for securing the connector parts together.

13. An electrical connector as recited in claim 12 wherein said lock comprises a locking element mounted to the socket part and which is engageable with a locking portion of a terminal pin of the connector.

14. An electrical connector as recited in claim 13 wherein said locking element comprises a locking surface for lockingly engaging an end of a or said spade tab provided on the terminal pin.

15. An electrical connector comprising:
a pin connector part comprising a plurality of terminal pins; and
a socket connector part for receiving said pins, said second part comprising:
a socket housing; and
a plurality of terminals within said socket housing for receiving said pins; and
a lock for securing said connector parts together, said lock comprising:
a locking element mounted to said socket housing and lockingly engageable with a locking portion of a said terminal pin.

16. An electrical connector as recited in claim 15 wherein the locking element is selectively engageable with the terminal pin.

17. An electrical connector as recited in claim 16 wherein locking element comprises an element which is selectively rotatable between a locking position in which it lockingly engages the terminal pin and a non-locking position in which it does not.

18. An electrical connector as recited in claim 17 wherein the locking element may be provided with a secondary lock which retains the locking element in its locking position.

19. An electrical connector as recited in claim 18 wherein the secondary lock comprises a detent provided on the socket part and a cooperating locking formation provided on the locking element, the cooperating locking formation being selectively disengageable from the detent to allow separation of the connector parts.

20. (canceled)

21. An electrical connector as recited in claim 19 wherein the locking formation is provided on a locking arm coupled to and movable with the locking element.

22. An electrical connector as recited in claim 21 wherein the detent and locking formation are configured such that the act of moving the locking element into locking engagement with the terminal pin automatically effects the secondary locking.

23. An electrical connector as recited in claim 22 wherein the detent and locking formation may have ramped surfaces which ride over one another as the locking element is moved to its locking position.

24. An electrical connector as recited in claim 23 wherein the locking arm is elongate, with the locking formation formed at one end of the locking arm, a pivot formed in a mid length section of the locking arm and a release portion formed at the other end of the locking arm.

25. An electrical connector as recited in claim 24 wherein the release section of the locking arm extends adjacent an actuating portion of the locking element.

26. (canceled)

27. (canceled)

28. (canceled)

29. An electrical connector comprising:
a pin connector part comprising a plurality of terminal pins; and
a socket connector part for receiving said pins, said second part comprising:
a socket housing; and
a plurality of terminals within said housing for receiving said pins;
wherein said pin connector part is arranged within a shroud for at least partially receiving said socket connector and wherein the configuration of the shroud and the socket connector are such that the socket connector can only be received within the shroud in a particular orientation.

30. (canceled)

31. (canceled)
